(19) United States
(12) Patent Application Publication
(10) Pub. No.: US 2006/0111545 A1
(43) Pub. Date: May 25, 2006

(54) Hydrophobic, solvent-free polyols stable to hydrolysis

(75) Inventors: Meike Niesten, Koln (DE); Gerhard Ruttmann, Burscheid (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/283,648

(22) Filed: Nov. 21, 2005

(30) Foreign Application Priority Data
Nov. 23, 2004 (DE) 102004056398.5

(51) Int. Cl. C08G 65/08

(52) U.S. Cl. 528/103

(57) ABSTRACT

The invention relates to new hydrophobic polyols stable to hydrolysis, to a process for preparing them and to solvent-free binder mixtures based on them, said mixtures being suitable particularly for corrosion control on metallic substrates and also for coating mineral (alkaline) substrates, for floor coatings, for example.

### CROSS-REFERENCE TO RELATED APPLICATION

This application claims priority to German application DE 10 2004 056398, filed Nov. 23, 2004.

### FIELD OF THE INVENTION

The invention relates to new hydrophobic polyols stable to hydrolysis, to a process for preparing them and to solvent-free binder mixtures based on them, said mixtures being suitable particularly for corrosion control on metallic substrates and also for coating mineral (alkaline) substrates, for floor coatings, for example.

### BACKGROUND OF THE INVENTION

Prior-art solvent-free two-component (2K) coating systems divide up essentially into epoxy resin (2K EP) systems and polyurethane (2K PU) systems.

Coatings based on 2K EP systems combine good mechanical strength with high resistance to solvents and chemicals. Additionally they are notable for very good substrate adhesion. A distinct disadvantage relative to the polyurethane systems is their poor elasticity, particularly at low temperatures. This brittleness leads to poor crack bridging by the coating, forming a possible site for attack on the substrate. An additional disadvantage is the very low stability to organic acids. This is a problem in particular for applications in the food sector, where organic acids are often released as waste products.

A balanced combination of hardness and elasticity, in contrast, is the outstanding property of the 2K PU coatings and their greatest advantage over 2K EP coatings. Moreover, with similar solvent resistance and chemical resistance properties, the resistance of 2K PU coatings to organic acids is substantially better than that of 2K EP coatings.

On environmental grounds, modern-day coating materials are nowadays required to be solvent-free. This applies in particular to coatings in the architectural sector, where the coatings are often applied in layers of high thickness, such as in the flooring segment, for example. In order to ensure a combination of low solvent content with good processing properties it is necessary to use coating components that are of correspondingly low viscosity. On way of achieving this is to use low-viscosity polyhydroxy compounds.

Critical to the suitability of a binder in the corrosion control sector for metallic substrates and also for the coating of mineral (alkaline) substrates is good resistance to saponification (hydrolysis). Polyester polyol binder components are therefore generally unsuited to this area of application. Similarly, owing to the ester bonds present, the use of castor oil, as described for example in Saunders, Frisch; Polyurethanes, Chemistry and Technology, Part 1 Chemistry, pages 48 to 53, does not give satisfactory results.

Owing to their relatively high tendency to absorb water, however, polyether polyols are also only of limited usefulness as a binder component for this field of application. When 2K PU systems are applied at high layer thicknesses, and particularly in situations of high atmospheric humidity, the correspondingly large amount of water absorbed can result in reaction with NCO groups, leading to CO₂ being given off. Owing to blistering in the coating film, this leads to inhomogeneities and turbidity.

2K PU coatings based on polyacrylate polyols are notable for high resistance to saponification; a drawback, however, is their relatively high level of viscosity. Consequently, either solvents or reactive diluents such as polyether polyols or polyfunctional alcohols are always added to adjust the viscosity. In just the same way as when polyether polyols are used alone as crosslinkers, this results, as a general rule, in an increase in the water absorption behaviour.

A further class of polyols can be attained by ring opening of epoxides with alcohols. For instance, oligomeric bisphenol A resins obtained by reacting bisphenol A with epichlorohydrin are well known from, for example, Kittel, Lehrbuch der Lacke und Beschichtungen, S. Hirzel Verlag, Stuttgart, Leipzig, second edition 1998, Part 2, pages 267-320.

Resins of this kind are typically used in combination with amines in 2K epoxide systems.

It is also possible, however, to react them with further diols or polyols such as bisphenol A to give hydroxy-functional compounds, whose use in coating systems has been diversely described. By varying the epoxy-functional and hydroxy-functional building blocks employed for this purpose it is possible to obtain resins having a variety of properties.

WO8304414 describes, by way of example, polyol resins which are obtained from aliphatic diepoxides, aromatic diepoxides and compounds containing at least 2 aromatic hydroxyl groups. These resins can be used with polyisocyanates in coating systems which cure at room temperature. Because of the high viscosities of the OH-functional resins described therein, however, they can be employed only in solvent-borne coating systems.

Through the additional use of monofunctional chain terminators such as monofunctional phenols, carboxylic acids, thiols or epoxides in the preparation of polyol resins of this kind, described in WO8304414 for example, it is possible to attain the molecular weight and hence the (melt) viscosity of the resins (WO 8 603 507, U.S. Pat. Nos. 5,334,676, 4,698,141, 4,868,230, EP-A 0 253 405). In spite of this the systems described therein do not attain viscosities which allow use in solvent-free coating materials.

WO 2004/067493 discloses solvent-free diols which are obtained by ring opening of epoxides with amines. Diols of this kind can be cured in principle using polyisocyanates, the presence of amine groups having a disruptive effect. Since the NCO/NH reaction is extremely quick, particularly when aromatic polyisocyanates are employed, systems of this kind cure too quickly, so that manual processing in high-build applications to give homogeneous, blister-free layers is virtually impossible.

It was therefore an object of the present invention to provide a hydrophobic, low-viscosity polyol component which can be further-processed manually to form solvent-free binder mixtures and which does not have the abovementioned disadvantages of the deficient stability of the coatings based thereon.

### SUMMARY OF THE INVENTION

It has now been found that the object set can be achieved by means of a polyol obtainable from specific epoxides and hydroxy-functional compounds.

The invention provides a process for preparing an ester-free hydrophobic polyol having an OH number of 100 to 500 mg KOH/g, an average OH functionality of 1.8 to 4.5, a viscosity at 23° C. of 1000 to 50 000 mPa.s and a water absorption after 21 days at 23° C. and a humidity of 97% of less than 5% by weight, wherein
A1) 10% to 40% by weight of a bisphenol corresponding to the general formula (I) 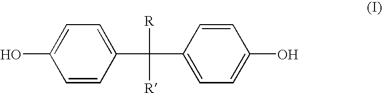
   where R and R′ independently of one another are hydrogen or an organic radical having 1 to 6 carbon atoms,
A2) 0 to 40% by weight of one or more aliphatic diglycidyl ethers having a number-average molecular weight of 200 to 700 g/mol and corresponding to the general formula (II) 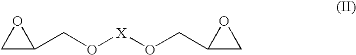
   where X is a divalent aliphatic hydrocarbon radical and
A3) 20% to 70% by weight either of one or more monofunctional aliphatic glycidyl ethers having a number-average molecular weight of 150 to 400 g/mol and corresponding to the general formula (III) 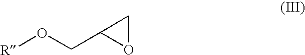
   where R″ is a monovalent, optionally oxygen-containing alkyl, aryl or aralkyl radical
   or of one or more monofunctional epoxides of the formula (IV) 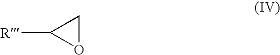
   where R′″ is a C₈-C₂₀ alkyl radical,
   or of a mixture of epoxides of the formulae (III) and (IV),
are reacted with one another, the molar ratio of epoxide groups from A1) to OH groups from A2) and A3) being 1:0.8 to 1:2.

Further provided by the present invention are the polyols prepared by the process that is essential to the invention.

### DETAILED DESCRIPTION OF PREFERRED EMBODIMENTS

As used herein, as used in the examples or unless otherwise expressly specified, all numbers may be read as if prefaced by the word “about”, even if the term does not expressly appear. Also, any numerical range recited herein is intended to include all sub-ranges subsumed therein.

In the process of the invention it is preferred to use 20% to 40% by weight of the above-described component A1).

In the process of the invention it is preferred to use 5% to 35% by weight of the above-described component A2).

In the process of the invention it is preferred to use 20% to 55% by weight of the above-described component A3).

With particular preference components A1) to A3) are used in amounts of 20% to 40% by weight of A1), 5% to 35% by weight of A2) and 20% to 55% by weight of A3).

The molar ratio of epoxide groups from A1) to OH groups from A2) and A3) is preferably 1:0.8 to 1:1.7.

In component A1) it is possible to use, for example, bisphenol A, bisphenol F or trimethylcyclohexylbisphenol. In Al) it is preferred to use bisphenol A.

In component A2) it is possible to use, for example, 1,2-ethanediol diglycidyl ether, 1,3-propanediol diglycidyl ether, 1,2-propanediol diglycidyl ether, 1,4-butanediol diglycidyl ether, 1,6-hexanediol diglycidyl ether, neopentyl glycol diglycidyl ether, cyclohexanedimethanol diglycidyl ether, glycerol diglycidyl ether, polypropylene glycol diglycidyl ethers or mixtures thereof. In A2) it is preferred to use 1,4-butanediol diglycidyl ether, 1,6-hexanediol diglycidyl ether and neopentyl glycol diglycidyl ether, particular preference being given to the use of 1,4-butanediol diglycidyl ether. The latter are available commercially, for example, under the names Polypox R3, Polypox R18 or Polypox R14 from the company UPPC Baltringen, Germany.

In component A3) it is possible to use, for example, 2-ethylhexyl glycidyl ether, dodecyl glycidyl ether, tetradecyl glycidyl ether, hexadecyl glycidyl ether, octadecyl glycidyl ether, monoepoxides of α-olefins having 8 to 20 carbon atoms, tert-butylphenol glycidyl ether, cresyl glycidyl ether, 2-methylphenyl glycidyl ether, 4-tert-butylphenyl glycidyl ether, 4-methoxyphenyl glycidyl ether, 3-pentadecadienylphenyl glycidyl ether or mixtures thereof. In A3) it is preferred to use mixtures of dodecyl glycidyl ether and tetradecyl glycidyl ether.

The polyols of the invention are typically prepared by mixing components A1) to A3) with one another in any order and simultaneously or subsequently heating the mixture at 50 to 200° C., preferably 100 to 180° C. The reaction can be carried out without catalyst or with the use of a catalyst. If a catalyst is used it may comprise any of the compounds and catalyst systems known per se to the skilled person, such as alkali metal hydroxides, tertiary amines, quaternary ammonium salts, quaternary phosphonium salts, trialkylphosphines or triarylphosphines, for example.

The reaction is typically carried out until complete reaction of the epoxy groups (determined in accordance with DIN 16945, the amount being based on a molar mass of 42 g/mol) can be detected.

The polyols thus obtainable preferably have a viscosity at 23° C. of 1000 to 50 000 mPa.s.

The polyols thus obtainable preferably have a number-average molecular weight of 500 to 2500 g/mol.

The polyols thus obtainable preferably have OH functionalities of 1.8 to 4.5 and OH numbers of 100 to 500 mg KOH/g.

The ester-free polyols of the invention that are obtainable in this way are distinguished by a particularly high hydrophobicity. They are particularly suitable, accordingly, for producing 2K polyurethane coating systems (2K PU systems) for high-build applications in, for example, the construction sector.

The water absorption of the polyols obtainable in accordance with the invention, after 21 days of 23° C. storage at a humidity of 97%, is preferably below 3% by weight.

The water absorption is determined by storing a sample openly at 23° C. and 97% atmospheric humidity for 21 days and then determining the weight gain.

The present invention accordingly further provides 2K PU systems at least comprising

a) one or more of the polyols of the invention and

b) one or more polyisocyanates.

Polyisocyanates of component b) that are used are typically organic polyisocyanates having an average NCO functionality of at least 2 and a molecular weight of at least 140 g/mol.

Highly suitable in particular are (i) unmodified organic polyisocyanates of the molecular weight range 140 to 300 g/mol, (ii) paint polyisocyanates having a molecular weight in the range from 300 to 1000 g/mol, and (iii) NCO prepolymers containing urethane groups and having a molecular weight of more than 1000 g/mol, or mixtures of (i) to (iii).

Examples of polyisocyanates of group (i) are 1,4-diisocyanatobutane, 1,6-diisocyanatohexane (HDI), 1,5-diisocyanato-2,2-dimethylpentane, 2,2,4- and/or 2,4,4-trimethyl-1,6-diisocyanatohexane, 1-isocyanato-3,3,5-trimethyl-5-isocyanatomethylcyclohexane (IPDI), 1-isocyanato-1-methyl-4-(3)-isocyanatomethylcyclohexane, bis(4-isocyanatocyclohexyl)methane, 1,10-diisocyanatodecane, 1,12-diisocyanatododecane, cyclohexane 1,3- and 1,4-diisocyanate, xylylene diisocyanate isomers, triisocyanatononane (TIN), 2,4-diisocyanatotoluene or its mixtures with 2,6-diisocyanatotoluene, containing preferably, based on mixtures, up to 35% by weight of 2,6-diisocyanatotoluene, or 2,2′-, 2,4′-, 4,4′-, diisocyanatodiphenylmethane or technical polyisocyanate mixtures of the diphenylmethane series, or any desired mixtures of the isocyanates stated.

Polyisocyanates of group (ii) are the paint polyisocyanates that are known per se. The term “paint polyisocyanates” comprehends, in the context of the invention, compounds or mixtures of compounds which are obtained by the conventional oligomerization reaction of simple diisocyanates of the type exemplified under (i). Examples of suitable oligomerization reactions are the carbodiimidization, dimerization, trimerization, biuretization, urea formation, urethanization, allophanatization and/or cyclization, with the formation of oxadiazine structures. In the “oligomerization” it is often the case that two or more of the said reactions run simultaneously or in succession.

The “paint polyisocyanates” (ii) are preferably biuret polyisocyanates, polyisocyanates containing isocyanurate groups, polyisocyanate mixtures containing isocyanurate and uretdione groups, polyisocyanates containing urethane and/or allophanate groups, or polyisocyanate mixtures containing isocyanurate and allophanate groups, said polyisocyanate (mixtures) being based on simple diisocyanates.

The preparation of paint polyisocyanates of this kind is known and is described for example in DE-A 1 595 273, DE-A 3 700 209 and DE-A 3 900 053 or in EP-A-0 330 966, EP-A-0 259 233, EP-A-0 377 177, EP-A-0 496 208, EP-A-0 524 501 or U.S. Pat. No. 4,385,171.

Polyisocyanates of group (iii) are the conventional prepolymers, containing isocyanate groups, that are based on simple diisocyanates of the type exemplified above and/or are based on paint polyisocyanates (ii) on the one hand and organic polyhydroxy compounds having a molecular weight of more than 300 g/mol on the other. While the paint polyisocyanates of group (ii) that contain urethane groups are derivatives of low molecular weight polyols of the molecular weight range 62 to 300 g/mol, examples of suitable polyols being ethylene glycol, propylene glycol, trimethylolpropane, glycerol or mixtures of these alcohols, the NCO prepolymers of group (iii) are prepared using polyhydroxyl compounds having a molecular weight of more than 300 g/mol, preferably more than 500 g/mol, more preferably a molecular weight of between 500 and 8000 g/mol. Particular such polyhydroxyl compounds are those which contain 2 to 6, preferably 2 to 3, hydroxyl groups per molecule and have been selected from the group consisting of ether-, ester-, thioether-, carbonate- and polyacrylate-polyols and mixtures of such polyols.

In connection with the preparation of the NCO prepolymers (iii) it is also possible for the stated polyols of relatively high molecular weight to be used in blends with the stated polyols of low molecular weight, so resulting directly in mixtures of low molecular weight paint polyisocyanates (ii) containing urethane groups and higher molecular weight NCO prepolymers (iii).

To prepare the NCO prepolymers (iii) or mixtures thereof with the paint polyisocyanates (ii), diisocyanates (i) of the type exemplified above or paint polyisocyanates of the type exemplified under (ii) are reacted with the relatively high molecular weight hydroxyl compounds or mixtures thereof with low molecular weight polyhydroxyl compounds of the type exemplified, observing an NCO/OH equivalent ratio of 1.1:1 to 40:1, preferably 2:1 to 25:1, in a reaction accompanied by urethane formation. If an excess of distillable starting diisocyanate is used it is possible as an option to remove said excess by distillation, following the reaction, so that monomer-free NCO prepolymers, i.e. mixtures of starting diisocyanates (i) and true NCO prepolymers (iii).

In b) it is preferred to use 2,2′-, 2,4′-, 4,4′-, diisocyanatodiphenylmethane or technical polyisocyanate mixtures of the diphenylmethane series or polyisocyanates of the above-defined group ii).

In the 2K PU systems of the invention the amounts of components a), b) and, where appropriate, further constituents are chosen so as to result in an NCO:OH equivalent ratio of0.5:1 to 2.0:1, preferably 0.8:1 to 1.5:1.

Besides a) and b), it is possible for further constituents to be present in the 2K PU systems of the invention, such as catalysts or auxiliaries and additives.

As catalysts it is possible to use the compounds which are known per se in polyurethane chemistry for accelerating the NCO/OH reaction (cf. “Kunststoff Handbuch 7, Polyurethane”, Carl-Hanser-Verlag, Munich-Vienna, 1984, pp. 97-98).

These catalysts may be, for example, the following: tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane, N,N′-dimethylpiperazine or metal salts such as iron(III) chloride, zinc chloride, zinc 2-ethylcaproate, tin(II) octoate, tin(II) ethylcaproate, tin(II) palmitate, dibutyltin(IV) dilaurate and molybdenum glycolate or any desired mixtures of such catalysts. Preferred for use as compounds of component C) are tin compounds.

As auxiliaries or additives it is possible to make use in the 2K PU systems of, for example, surface-active substances, internal release agents, fillers, dyes, pigments, flame retardants, hydrolysis stabilizers, microbicides, flow control assistants, antioxidants such as 2,6-di-tert-butyl-4-methylphenol, UV absorbers of the 2-hydroxyphenylbenzotriazole type or light stabilizers of the type of the HALS compounds which are unsubstituted or substituted on the nitrogen atom, such as Tinuvin® 292 and Tinuvin® 770 DF (Ciba Spezialitaten GmbH, Lampertheim, Del.) or other commercially customary stabilizers, as described for example in “Lichtschutzmittel fur Lacke” (A. Valet, Vincentz Verlag, Hannover, 1996 and “Stabilization of Polymeric Materials” (H. Zweifel, Springer Verlag, Berlin, 1977, Appendix 3, pp. 181-213).

For preparing the 2K PU systems of the invention components a) and b) are mixed with one another so as to result in an NCO:OH equivalent ratio of 0.5:1 to 2.0:1, preferably 0.8:1 to 1.5:1. During or after this mixing of the individual components it is possible, if desired, for the stated auxiliaries and additives, and also catalysts, to be mixed in.

The 2K PU systems of the invention can be applied by methods which are customary per se in the art, such as brushing, knife coating, spraying and dipping.

Preferred coat thicknesses are from 0.5 to 10 mm, preferably from 0.7 to 6 mm, without this ruling out the production of thinner or thicker coats.

In principle, using the 2K PU systems of the invention, it is possible to coat all kinds of materials. Examples that may be mentioned include glass, wood, metal and mineral substrates such as concrete.

It is preferred to use the 2K PU systems for producing coatings for protecting metallic substrates against mechanical damage and corrosion and also for protecting mineral substrates, such as concrete for example, against environmental effects and mechanical damage.

### EXAMPLES

Unless noted to the contrary, all percentages are by weight.

The dynamic viscosities were determined in accordance with DIN 53019 at 23° C. using a rotational viscometer (Viscotester 550, Thermo Hakke GmbH, D-76227 Karlsruhe) at a shear rate of 40 s⁻¹.

The reported OH numbers were determined in accordance with DIN 53240 Part 2.

The epoxide group content was determined in accordance with DIN 16945 and is based on a molar mass of 42 g/mol.

The Shore D hardness was determined in accordance with DIN 53505.

The water absorption was determined by the weight gain of a sample after 21 days of open storage at 23° C. and 97% atmospheric humidity.

The water absorption is defined in accordance with the following formula:

$$Water absorption ( \% ) = 100 \times ( \frac{{weight}_{21 days} - {weight}_{initial}}{{weight}_{initial}} )$$

Desmodur® VL

Polyisocyanate based on 4,4′-diphenylmethane diisocyanate and having an NCO content of 31.5% and a viscosity at 23° C. of 90 mPa.s, Bayer MaterialScience, Leverkusen, Del.

Preparation of Polyol 1

A mixture of 1276 g of bisphenol A, 1541 g of Polypox R3 (1,4-butanediol diglycidyl ether, epoxy equivalent weight 138 g, UPPC, Baltringen, Germany), 1753 g of technical dodecyl/tetradecyl glycidyl ether (epoxy equivalent weight of 313 g, Aldrich) and 45.8 g of triphenylphosphine was stirred at 170° C. for two hours and then cooled to room temperature. The polyol had an OH number of 185 mg KOH/g, an epoxy group content of 6.0% by weight, a viscosity at 23° C. of 4370 mPa.s and a water absorption of 2.6% by weight.

Preparation of Polyol 2

A mixture of 55.0 g of bisphenol, 66.3 g of Polypox (1,4-butanediol diglycidyl ether, epoxy equivalent weight 138 g, UPPC, Baltringen, Germany), 126.7 g of Cardolite NC513 (glycidyl ether of 3-alkylphenol and CH₂OCHCH₂OC₆H₄C₁₅H₂₇, having an epoxy equivalent weight of 525 g, Cardanol Chemicals, Mechelen, Belgium) and 2.5 g of triphenylphosphine was stirred at 170° C. for two hours and then cooled to room temperature. The polyol had an OH number of 170 mg KOH/g, an epoxy group content of 39% by weight, a viscosity at 23° C. of 11 800 mPa.s and a water absorption of 1.1% by weight.

Polyol 3 (Comparative)

Desmophen® 1150, commercial product of Bayer MaterialScience, Leverkusen, Germany. With an OH number of 155 mg KOH/g and a viscosity of 3500 mPa.s and a water absorption of 1.2% by weight.

Polyol 4 (Comparative)

Desmophen® VPLS 2328, commercial product of Bayer MaterialScience AG, Leverkusen, Germany, solvent-free polyester having an OH number of 257 mg KOH/g and a viscosity at 23° C. of 800 mPa.s and a water absorption of 6.2% by weight.

Polyol 5 (Comparative)

A mixture of 22.8 g of bisphenol A, 35.0 g of DER 358 (mixture of bisphenol A diglycidyl ether, bisphenol F diglycidyl ether and 1,6-hexanediol diglycidyl ether, epoxy equivalent weight 175 g, DOW Chemicals, Germany), 31.3 g of technical dodecyl/tetradecyl glycidyl ether (epoxy equivalent weight of 313 g, Aldrich, Germany) and 0.9 g of triphenylphosphine was stirred at 170° C. for two hours and then cooled to room temperature. The polyol has a viscosity at room temperature (23° C.) >200 000 mPa.s and consequently is impossible to process manually.

### Examples 1 to 3

To prepare the 2K PU systems of the invention the polyol component was mixed with the polyisocyanate component in an NCO/OH ratio of 1:1 (amounts as per Table 1) and the mixture was poured onto a plastics substrate in a coat thickness of 3 to 5 mm. Subsequent curing took place by storage of the plates at room temperature for 7 days.

TABLE 1

| Composition (parts by weight) | 1 | 2 | 3 |
|---|---|---|---|
| Polyol 1 | 100 | 0 | |
| Polyol 2 | | 100 | |
| Polyol 3 | | | 100 |
| Desmodur ® VL | 45 | 41 | 39 |
| Hardness (Shore D) | 74 | 55 | 52 |
| Hardness (Shore D) after 28-day storage at | 76 | 56 | 32 |
| 70° C. in 10% strength NaOH | | | |
| Hardness (Shore D) after 28-day storage at | 76 | 58 | 32 |
| 70° C. in 10% strength sulphuric acid | | | |

The solvent-free polyols of the invention are notable for good stability towards hydrolysis. After the cured samples have been stored in NaOH and sulphuric acid, no substantial loss of hardness was observed when the polyols essential to the invention were employed. Furthermore, they have a very low water absorption of <5% by weight. Comparative polyol 5 shows that, if an aromatic diglycidyl ether is used instead of an aliphatic diglycidyl ether, the polyols can no longer be prepared without solvent, owing to the sharply rising viscosity.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for preparing ester-group-free hydrophobic polyols having an OH number of 100 to 500 mg KOH/g, an average OH functionality of 1.8 to 4.5, a viscosity at 23° C. of 1000 to 50 000 mPa.s and a water absorption after storage for 21 days at 23° C. and a humidity of 97% of less than 5% by weight, wherein
A1) 10% to 40% by weight of a bisphenol corresponding to the general formula (I) 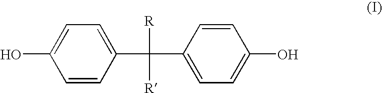
where R and R′ independently of one another are hydrogen or an organic radical having 1 to 6 carbon atoms,
A2) 0 to 40% by weight of one or more aliphatic diglycidyl ethers having a number-average molecular weight of 200 to 700 g/mol and corresponding to the general formula (II) 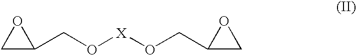
where X is a divalent aliphatic hydrocarbon radical and
A3) 20% to 70% by weight either of one or more monofunctional aliphatic glycidyl ethers having a number-average molecular weight of 150 to 400 g/mol and corresponding to the general formula (III) 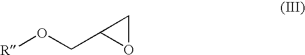
where R″ is a monovalent, optionally oxygen-containing alkyl, aryl or aralkyl radical
or of one or more monofunctional epoxides of the formula (IV) 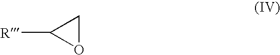
where R′″ is a C₈-C₂₀ alkyl radical,
or of a mixture of epoxides of the formulae (III) and (IV),
are reacted with one another, the molar ratio of epoxide groups from A1) to OH groups from A2) and A3) being 1:0.8 to 1:2.

2. Process according to claim 1, wherein components A1) to A3) are used in amounts of 20% to 40% by weight of A1), 5% to 35% by weight of A2) and 20% to 55% by weight of A3).

3. Process according to claim 1 or 2, wherein the ratio of epoxide groups from A1) to OH groups from A2) and A3) is 1:0.8 to 1:1.7.

4. Ester-group-free hydrophobic polyols obtained by a process according to claim 1.

5. 2K PU systems at least comprising
a) one or more ester-group-free hydrophobic polyols according to claim 4, and
b) one or more polyisocyanates.

6. Coatings obtained using ester-group-free hydrophobic polyols according to claim 4.
